(19) United States
(12) Patent Application Publication
(10) Pub. No.: US 2011/0257810 A1
(43) Pub. Date: Oct. 20, 2011

(54) ONBOARD VEHICLE SYSTEM AND METHOD FOR CONFIGURING VEHICLE FUNCTIONALITIES

(75) Inventor: Hugues Leger, Villeurbanne (FR)

(73) Assignee: RENAULT TRUCKS, Saint Priest (FR)

(21) Appl. No.: 13/141,790

(22) PCT Filed: Dec. 30, 2008
(86) PCT No.: PCT/IB08/55698

§ 371 Date: Jun. 23, 2011

(51) Int. Cl. G06F 17/00

(52) U.S. Cl. 701/1

(57) ABSTRACT

An onboard vehicle control system includes a vehicle electronic control adapted to control at least one vehicle functionality, a human machine interface communicating with the vehicle electronic control and including a human input interface. The vehicle electronic control includes a preloaded configuration program for configuring the vehicle functionality and the vehicle electronic control is adapted to, upon manual entry of an activation code by a user with the human input interface, execute the preloaded configuration program which modifies the vehicle functionality settings.

### BACKGROUND AND SUMMARY

The invention is directed to configuration tools enabling a user or a bodybuilder to configure several functionalities of a vehicle. The invention is more particularly directed to onboard vehicle systems and methods for configuring vehicle functionalities.

On commercial vehicles or heavy duty vehicles such as trucks equipped by bodybuilders with various equipments and body before being retailed to an end-user, the bodybuilder may need, to configure one or more functionalities of the trucks, such as the electrical interface, the engine settings, the speed-limits and so on . . . . In order to achieve such a configuration, the vehicle manufacturer rents or sells to body builders dedicated configuration tools and softwares enabling the body builder to reconfigure the vehicle using a dedicated hardware interface provided by the vehicle control system. Such bodybuilder tools are quite expensive because of their several functionalities and high level of sophistication and security. Therefore, these bodybuilder tools are affordable only to bodybuilders achieving high volumes of sales or producing very sophisticated vehicles and not for bodybuilders achieving low volume or simple low cost vehicles. Therefore, the need appears for a new kind of tools allowing the configuration of at least one functionality of a vehicle at a much lower price than the price of dedicated configuration tools and even making the configuration of the vehicle possible for end-users.

In this respect it is desirable to provide an onboard vehicle control system comprising:
vehicle electronic control means being adapted to control at least one vehicle functionality;
a human machine interface communicating with the vehicle electronic control means and comprising a human input interface.

According to an aspect of the invention, the vehicle electronic control means comprise a preloaded configuration program for configuring the vehicle functionality and the vehicle electronic control means are adapted to, upon manual entry of an activation code by a user with the human input interface, execute the preloaded configuration program which modifies the vehicle functionality settings.

The use of the human machine interface for manual entry of an activation code activating a preloaded configuration program allows the user to configure the vehicle without any dedicated configuration tools, generally known as bodybuilder tools. Therefore the configuration can be conducted in a cheaper way than with the dedicated configuration tools. Furthermore, an aspect of the invention enables configuring by unskilled end-users who may activate after buying the vehicle various comfort options which were not before activated.

According to an embodiment of the invention, the activation code comprises: a key index or memory address, settings for the functionality to be configures and a vehicle identification number. In an implementation of such embodiment, the preloaded configuration program copies the settings at the key index or memory address.

According to an aspect of the invention, not only one but several options or functionalities of the vehicle may be configured through the human machine interface. In this respect according to an embodiment of the invention:
the vehicle electronic control means may be adapted to control several vehicle functionalities each functionality being associated with a key index.
the activation code will comprise at least one key index of one functionality;
the vehicle control means will be adapted to execute the preloaded configuration program which modifies the settings of the functionality corresponding to each key index of the entered activation code. In order to provide a good traceability of the modifications of the configuration of the vehicle, according to an aspect of the invention, the vehicle electronic control means comprise:
a local configuration journal, each modification of the settings of each vehicle functionality being recorded in the configuration journal; and
means for reading or upload the local configuration journal.

According to an aspect of the invention, settings or parameters for the functionality to be configured may be provided to the preloaded configuration program before or after imputing the activation code but also while imputing the activation code.

Therefore, according to an aspect of the invention, the activation code comprises settings for the corresponding functionality.

The onboard vehicle control system may also enable sophisticated configuration such as firmware update for hardware device of the vehicle or configuration program for implementing a new functionality, not already loaded on the vehicle controls system. In this respect, the preloaded configuration program may be completed with another program or piece of program provided to the user along with the activation code. In order to allow the implementation of such a complementary configuration program:
the vehicle implementing the onboard vehicle control system comprises an onboard memory interface for an external memory device and one functionality of the vehicle being enabling communication between the onboard vehicle control system and the onboard external memory interface;
the preloaded configuration program is adapted to, upon entry of a dedicated activation code, make the vehicle electronic control means:
activate, if not already activated, the communication functionality between the onboard vehicle control system and the onboard external memory interface;
download, from an external memory device associated with the onboard external memory interface, a complementary configuration program for at least one vehicle functionality; and
implement the complementary configuration program.

According to an aspect of this embodiment, the preloaded configuration program may be adapted to make the vehicle electronic control means deactivate the communication functionality after the download of the complementary configuration program.

According to another aspect of this embodiment, the activation code and/or the complementary configuration program comprises at least one authenticity certificate and the onboard vehicle control system comprise authentication means adapted to challenge the authenticity certificate and to execute the preloaded configuration program and the downloaded complementary program only if authenticity is found. The authentication means may be of any suitable type and may comprise dedicated secure processor and memory. The implementation of certificate prevents the use of unauthorized complementary configuration programs and therefore gives a high level of security to the onboard control system according to an aspect of.

In order to increase the security level of the onboard vehicle control system, other security measures may be implemented, for example, a vehicle identification number VIN may be used and accordingly:
the vehicle electronic control means comprise or has access to a onboard vehicle identification number identifying the vehicle implementing the onboard control system;
the activation code comprises a vehicle identification number;
the vehicle electronic control means are adapted to compare the vehicle identification number of the activation code with the on-board vehicle identification number and, only if the two vehicle identification numbers match, execute the corresponding preloaded configuration program. Another security measure, which may be implemented, is the use of cryptographic methods and protocols, accordingly:
the activation code is at least partly encrypted; and
the vehicle electronic control means comprise cryptographic means adapted to decrypted the activation code. The encryption method used may be any kind of cryptographic method such as for example symmetric encryption or public key/private key encryption.

According to an aspect of the invention, the human input interface may be situated on any adapted location of the vehicle. According to a preferred embodiment of the onboard vehicle control system, the human input interface is situated inside a driving cab of the vehicle and preferably set on the dashboard.

The invention concerns also, according to an aspect thereof, a method for configuring at least one functionality of a vehicle. According to an aspect of the invention this method comprises the following steps:
provision of an activation code to a user;
manual input of the activation code by the user with a human input interface of a human machine interface of the vehicle;
after input of the activation code execution of a preloaded configuration program which modifies the vehicle functionality settings.

According to an aspect of the invention, the method, further comprises the step of providing the vehicle with several configurable functionalities, each being associated with a key index; and wherein the activation code comprises at least one key index for identifying each functionality to be configured by the preloaded configuration program.

According to an embodiment of the configuring method, the configuration program activates the downloading of a complementary configuration program from an external memory device physically associated with the vehicle and implements the complementary configuration program. According to an aspect of the configuring method, the activation code and/or complementary configuration program is encrypted before being provided to the user, inputted by the user in an encrypted form and decrypted before activation of the corresponding preloaded configuration program.

According to another aspect of the invention, the activation code and/or complementary configuration program is associated or comprises at least one authenticity certificate and the authenticity certificate is challenged before activation of the corresponding preloaded configuration program.

According to an aspect of the invention, the provision of the activation code may be achieved in various ways for example the activation code can be provided by regular mail to the user after a request sent by either regular mail or email. The provision of the activation code may be also requested and provided using electronic communication means, such as internet and web access, mailing and SMS or MMS.

According to an embodiment of the method according to an aspect of the invention, the provision of the activation code comprises the following steps:
transmission by the user to a configuration authority of a vehicle identification number VIN of the vehicle to be configured,
indication by the configuration authority to the user of the functionalities and eventually the corresponding settings available for configuration of the vehicle corresponding to the vehicle identification number;
selection by the user of at least one functionality to be configured and eventually selection by the user of the corresponding settings;
provision to the user of the activation code according to the selection;
recording in a vehicle configuration database of the selection of the user in relation with the vehicle corresponding to the vehicle identification number.

According to an aspect of the invention, the activation code may be provided to the user after payment of a given amount of money. The invention concerns also, according to an aspect thereof, a vehicle implementing the onboard vehicle control system and/or the configuration method according to the invention. Such vehicle according to an aspect of the invention may be any kind of vehicle including personal cars, buses, light or heavy trucks and also equipment construction machines; this list being neither comprehensive nor limitative. The various above aspects, embodiments or objects of the invention may be combined in various ways with each others provided the combined aspects, embodiments or objects are not incompatible or mutually exclusive.

### DESCRIPTION OF THE FIGURES

Other aspect and advantages of the present invention will be apparent from the following detailed description made in conjunction with the accompanying drawing illustrating schematically some non-limitative embodiments of the invention.

FIG. 1 is a synoptic view of an embodiment of the method for configuring a vehicle according to the invention.

FIG. 2 is a schematic view of a vehicle implementing an on board configuration system.

Corresponding reference numbers indicate corresponding components in the various embodiments illustrated in the drawings.

### DETAILED DESCRIPTION

An object of the invention is to provide end users and/or body builders onboard means for configuring at least one and preferably several functionalities of a vehicle V using an activation code, which will be manually input on a human machine interface of the vehicle to be configured.

One step of this configuration process will be the provision of an activation code to the user. Such provision may be achieved by many ways. For example, this activation code may be provided along with a user's manual of the vehicle.

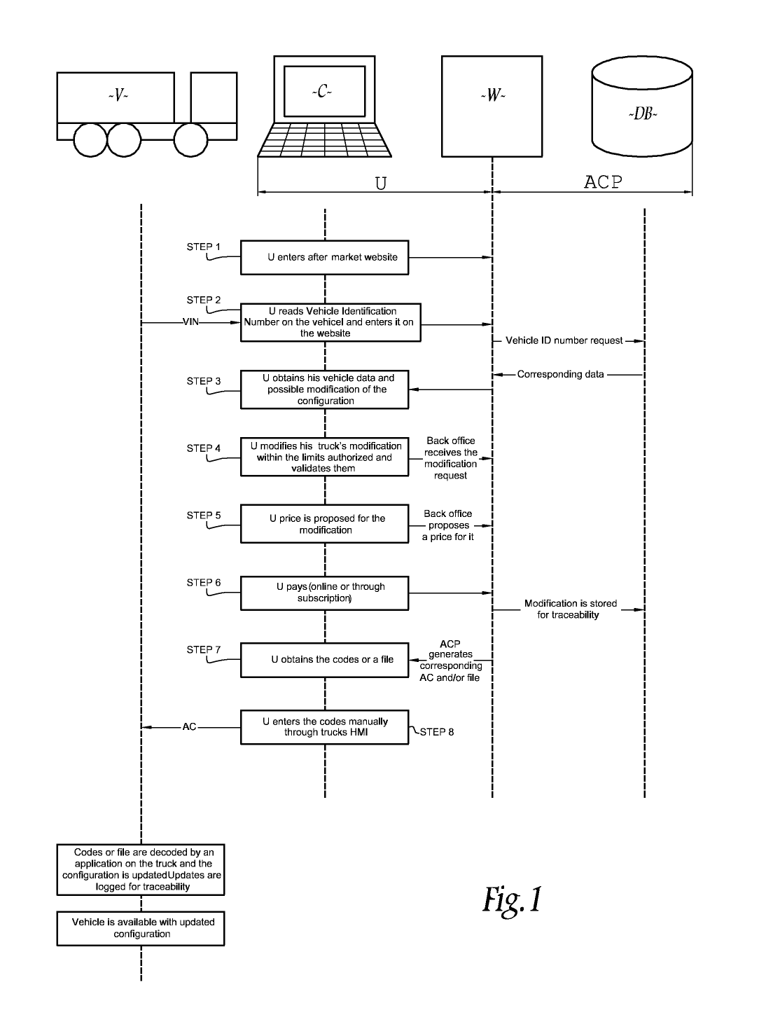

The activation code may also be provided to the user upon request and after selection of settings corresponding to the feature to be configured. FIG. 1 illustrates an example of an activation code provision process implementing internet and web interfaces. Naturally, a same kind of process can also be conducted using vocal servers and the activation code may provided to the user vocally or by using any kind of suitable media such as emails or SMS. As shown on FIG. 1, at the beginning (step 1) of the activation code provision process, the user U accesses an activation code provider ACP website W using a computer C. Naturally, the connection of the user to the website W might involved any state of the art identification and authentication procedure.

Once, the communication is established between computer C and website W, in a second step 2, the user U enters the vehicle identification number VIN of the vehicle V to be configured. The VIN is a unique identification given by the vehicle manufacturer to each vehicle. The VIN may be read on an identification plate of the vehicle V as well as on the documentation provided to the user U by the vehicle manufacturer. The website W will use the VIN for requesting in a vehicles database DB corresponding data comprising the features or functionalities of said vehicle available for configuration. At a step 3, the web site communicates the result of its request and the features which may be configured. These features available for configuration may for example comprise:
instrument cluster configurations, such as colour, theme, sound, luminosity and so on
comfort light configuration (for day driving, night driving, resting, animation of light at locking, unlocking doors)
vehicle speed threshold,
engine speed for power take off,
electric power available for bodybuilder equipment on hybrid vehicles or electric vehicles such a list being neither comprehensive nor limitative. These features might also be different from a vehicle to another.

At a step 4, the user U will choose, through the web interface, which of the functionalities he wants to configure and eventually the configuration parameters of the chosen functionality. When user U has validated his choices, the activation code provider ACP may request (step 5) the payment of a given price corresponding to the feature or functionality chosen. The payment can be conducted through regular payment procedure well-known on websites such as using credit card, prepaid tokens or by inputting the purchase on a user account held by the activation code provider ACP. Naturally, any other kind of payment or actions equivalent to payment may be implemented. Furthermore such payment is not compulsory for implementing the invention.

At a next step 6, the transaction is finalised and the website stores the choice of the user U in the vehicle database DB with respect to the VIN, so that the history of the amendments to the vehicle configuration will be stored in the database and available when needed for a next amendment of the configuration or for the maintenance of the vehicle V.

A last step 7 of the activation code provision process, the website provides at least one activation code AC to the user U. The activation code will be preferably, but not necessarily, provided in an encrypted form in order to prevent activation code forgery. Furthermore, one activation code might be provided for each functionality to be configured. Each activation code in its encrypted form may comprise for example a sequence of ASCII characters. The activation code comprises for example the VIN of the vehicle to be configured along with a key index of a functionality to be configured and, possibly parameters or settings for configuring the corresponding functionality. The activation code AC may also comprise more than one key index each eventually associated with parameters or settings for the corresponding functionality. Each key index of the activation code may simply correspond to a memory address or a range of memory addresses of a controller of the vehicle V where settings of the functionality to be configured are stored and the parameters embedded in the activation code will be new settings to be copied at said address or range of addresses.

Once the user is provided with the relevant activation code, the next step of the configuration will take place on the vehicle V.

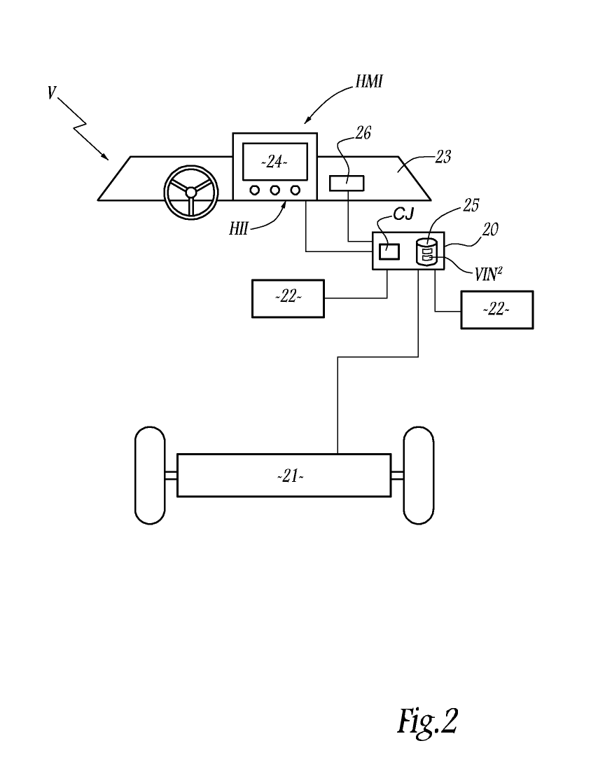

In order to enable the configuration, the vehicle V, as schematically illustrated FIG. 2 and designated as a whole by reference V, comprises vehicle electronic control means 20 adapted to control at least one and preferably several vehicle functionalities as listed above. The vehicle electronic control means, may for example, comprise a vehicle controller 20 which pilots at least a vehicle drive system 21 as well as others vehicle functionalities or devices 22. The vehicle control means may also be formed by a plurality of electronic controllers communicating with each others using, for example, controller area network CAN. These electronic controllers may be individual devices or embedded with the devices or the functionalities they control.

The vehicle V comprises also human machine interface HMI communicating with the vehicle control means 20. On the shown example, the human machine interface HMI is situated on the dashboard 23 of the vehicle and comprises a TFT screen. The HMI comprises also a human input interface HII comprising on the shown example three buttons for selecting items shown by the scream 24. Naturally, the human input interface HII may be of any other suitable type and may be formed by the screen 24 being therefore a touch screen. The human input interface HII can also be formed by a conventional keyboard or any other means allowing a manual input of the activation by the user including any set of stalks or buttons present in the vehicle to control other functions of said vehicle.

Vehicle control means 20 further comprise memory means comprising at least a preloaded configuration program along with a software controlling the functionalities available for configuration. Said software may be associated with a dataset db of running parameters for the functionalities stored in a memory of the ECU. Each configurable functionality will preferably be associated with a key index or address of the dataset db for retrieval of at least one running parameter by the control software and configuration by the preloaded configuration program. Each key index may therefore simply be an address or a range of addresses of the memory where the dataset db is stored.

In a next step 8 of the configuration process taking place on board, the user U enters manually the activation code AC previously provided by the activation code provider ACP using the human input interface HII. If this activation code is entered in an encrypted form, the vehicle electric control means proceed to a decryption of this activation code. The cryptographic protocol used for encrypting/decrypting the activation code can be for example a symmetric or a public key protocol. The decryption by the vehicle electronic control means of the activation code forms a first level of security.

Then, the vehicle electronic control means extract from the activation code the vehicle identification number VIN and compare it to a vehicle identification number VIN2 recorded in the vehicle control means. If the two numbers do not match, the configuration process will be stopped and an error message might be prompt on the screen 24. To the contrary, if the vehicle identification numbers VIN, VIN2 match, the vehicle configuration will proceed.

The vehicle electronic control means 20 extract from the activation code the index of the vehicle functionality to be configured. This extracted index is used by the preloaded configuration program for identifying the functionality or the parameters to be configured. The extracted index is for example the address of a running parameter which needs to be changed to configure the functionality. By the wording “configure” it should be understood that the corresponding functionality can be enabled or disabled but also, if already enabled, have its setting modified according, for example, to parameters which would have been embedded within the activation code. This configuration is for example done by modifying the data, of the dataset db, corresponding to the embedded index. Indeed, the activation code may also comprise the new value to be copied at said address.

When the preloaded configuration program has achieved the configuration modifications, these modifications will be logged in an onboard configuration journal CJ recorded in the memory of the vehicle electronic control means 20. This onboard journal of modifications will allow a user or mechanic working on the vehicle to have a history of the amendments to the configuration of the vehicle and/or to have a current status of its configuration. According to the invention the preloaded configuration program may be recorded or preloaded in the vehicle electronic control means 20 before release of the vehicle. The preloaded configuration program can also be loaded, after release of the vehicle and before implementation of the invention, through conventional dedicated configuration tools. In the embodiment of the configuration process or method previously described, the configuration process involves only an activation code AC communicated to the user by an activation, code provider ACP, but according to the invention, the configuration process can also involve a complementary configuration program CCP, which will be provided to the user by the activation code provider at the step 7 of activation code provision process. The user records this complementary activation code on any adapted memory device, such as a CD, a DVD, a flash memory device or an external hard drive. Before initiating the configuration process of the vehicle, the user associates this memory device with the vehicle. En case of a CD or DVD, the user will insert, it in an ad-hoc reader provided by the HMI. In case the memory device comprises a flash memory, the user may insert it also an ad hoc reader. The user may also connect the external memory device to a dedicated connection interface 26 such as a USB interface or any other suitable dedicated connection interface.

The input of the activation code provided along with the complementary configuration program will make the preloaded configuration program enabling a loading from the external memory of the complementary configuration program by the vehicle electronic control means 20. After this loading, the complementary configuration program will be implemented and the configuration of the vehicle achieved accordingly. The complementary configuration program can be a data file for amending the data set db and/or a piece of software for controlling one or more functionality of the vehicle.

In order to prevent forgery and the loading of unauthorized complementary configuration program, the later and the corresponding activation code can be associated with certificates issued by third part certification authorities or by the activation code provider. The complementary configuration program can also be encrypted and decrypted by the vehicle electronic control means 20, which will therefore implement all the cryptographic utilities needed. In the previously described embodiments, the functionalities of the vehicle to be configured are chosen on the web interface, while communicating with the activation code provider. According to another embodiment of the invention, the selection of the feature or functionality to be configured is done by the user with the on board human machine interface HMI and the input of the activation code takes place either before or after the selection process. Nevertheless, the input of the activation code will trigger the running of an inactivated preloaded configuration program or an activated part of the preloaded configuration program.

While the invention has been shown and described with reference to certain embodiments thereof, it would be understood by those skilled in the art that changes in form and details may be made therein without departing from the spirit and scope of the invention as defined in the appended claims.

1. Onboard vehicle control system comprising:
vehicle electronic control means being adapted to control at least one vehicle functionality;
a human machine interface communicating with the vehicle electronic control means and comprising a human input interface, wherein the vehicle electronic control means comprise a preloaded configuration program for configuring the vehicle functionality and the vehicle electronic control means are adapted to, upon manual entry of an activation code by a user with the human input interface, execute the preloaded configuration program which modifies the vehicle functionality settings.

2. Onboard vehicle control system according to claim 1, wherein the activation code comprises:
a key index or memory address;
settings for the functionality;
a vehicle identification number.

3. Onboard vehicle control system according to claim 2, wherein the preloaded configuration program copies the settings at the key index or memory address.

4. Onboard vehicle control system according to claim 1, wherein:
the vehicle electronic control means are adapted to control several vehicle functionalities, each functionality being associated with a key index;
the activation code comprises at least one key index of one functionality;
the vehicle control means are adapted to execute the preloaded configuration program which modifies the settings of vehicle functionality corresponding to each key index of the entered activation code.

5. Onboard vehicle control system according to claim 1, wherein the vehicle electronic control means comprise a local configuration journal, each modification of the settings of each vehicle functionality being recorded in the configuration journal.

6. Onboard vehicle control system according to claim 1, wherein the activation code comprises settings for the preloaded configuration program or each corresponding functionality.

7. Onboard vehicle control system according to claim 1, wherein:
the vehicle electronic control means comprise or have access to an onboard vehicle identification number identifying the vehicle implementing the onboard control system;
the activation code comprises a vehicle identification number;
the vehicle electronic control means are adapted to compare the vehicle identification number of the activation code with the onboard vehicle identification number and, only if the two vehicle identification numbers match, execute the preloaded configuration program.

8. Onboard vehicle control system according to claim 1, wherein:
the vehicle implementing the onboard vehicle control system comprises an onboard interface for an external memory device and one functionality of the vehicle being enabling communication between the onboard vehicle control system and the onboard interface;
the preloaded configuration program is adapted to, upon entry of a dedicated activation code, make the vehicle electronic control means:
activate, if not, the communication functionality between the onboard vehicle control system and the onboard external memory interface;
download, from an external memory device associated with the onboard external memory interface, a complementary configuration program for at least one vehicle functionality; and
implement the complementary configuration program.

9. Onboard vehicle control system according to claim 8, wherein the preloaded configuration program is adapted to make the vehicle electronic control means deactivate the communication functionality after the download of the complementary configuration program.

10. Onboard vehicle control system according to claim 8, wherein the activation code and/or the complementary configuration program comprises at least one authenticity certificate and the onboard vehicle control system comprise authentication means adapted to challenge the authenticity certificate and to execute the preloaded configuration program and/or the downloaded complementary configuration program only if authenticity is found.

11. Onboard vehicle control system according to claim 1, wherein:
the activation code is at least partly encrypted;
the vehicle electronic control means comprise cryptographic means adapted to decrypt the activation code.

12. Onboard vehicle control system according to claim 1, wherein the human input interface is situated inside a driving cab of the vehicle.

13. Method for configuring at least one functionality of a vehicle comprising the following steps:
provision of an activation code to a user;
manual input of the activation code by the user with a human input interface of a human machine interface of the vehicle;
after input of the activation code, execution of a preloaded configuration program which modifies the vehicle functionality settings.

14. Method according to claim 13, further comprising the step of providing the vehicle with several functionalities being configurable, each configurable functionality being associated with a key index; and wherein the activation code comprises at least one key index for identifying each functionality to be configured by preloaded configuration program.

15. Method according to claim 13, wherein the activation code comprises settings for the preloaded configuration program or the corresponding functionality.

16. Method according to claim 13, wherein the activation code comprises a vehicle identification number and the preloaded configuration program is activated and execute only if the vehicle identification number of the activation code matches with an onboard vehicle identification number.

17. Method according to claim 13, further comprising the step of logging each modification of each vehicle functionality in a local modification journal recorded in the vehicle.

18. Method according to claim 13, wherein the preloaded configuration program activates the downloading of a complementary configuration program from an external memory device physically associated with the vehicle and implements the complementary configuration program.

19. Method according to claim 13, wherein the activation code and/or complementary configuration program is encrypted before being provided to the user, inputted by the user in an encrypted form and decrypted before activation of the corresponding preloaded configuration program.

20. Method according to claim 13, wherein the activation code and/or complementary configuration program is associated or comprises at least one authenticity certificate and the authenticity certificate is challenged before activation of the corresponding preloaded configuration program.

21. Method according to claim 13, wherein the provision of the activation code comprises the following steps:
transmission by the user to a configuration authority of the vehicle identification number of the vehicle to be configured,
indication by the configuration authority to the user of the functionalities and eventually the corresponding settings available for configuration of the vehicle corresponding to the vehicle identification number;
selection by the user of at least one functionality to be configured and eventually selection by the user of the corresponding settings;
provision to the user of the activation code according to the selection;
recording in a vehicles configuration database of the selection of the user in relation with the vehicle corresponding to the vehicle identification number.
